(19) United States
(12) Patent Application Publication
(10) Pub. No.: US 2004/0236626 A1
(43) Pub. Date: Nov. 25, 2004

(54) Commercial/residential oil heating fuel status monitoring invention detailed process flow

(76) Inventor: Stephen Lynch, West Hartford, CT (US)

Correspondence Address: John C. Hilton, McCormick, Paulding & Huber, LLP, City Place II, 185 Asylum Street, Hartford, CT, 06103, US

(21) Appl. No.: 10/809,079

(22) Filed: Mar. 25, 2004

Related U.S. Application Data
(60) Provisional application No. 60/458,463, filed on Mar. 28, 2003.

(51) Int. Cl. G06F 17/60

(52) U.S. Cl. 705/10; 705/412; 705/413; 137/1; 141/192

(57) ABSTRACT

A computerized oil/fuel customer/supplier storage and inventory control system programmed to generate work orders and purchase orders for the customer, the supplier respectively depending upon predetermined/preprogrammed levels of oil/fuel at the customer and supplier's locations respectively.

### CROSS REFERENCE TO RELATED APPLICATIONS

This utility application incorporates by reference and claims priority to a prior provisional application entitled “PC Program for Oil Service or Oil Distribution Company,” filed in the USPTO on Mar. 28, 2003 and assigned Ser. No. 60/458,463.

### FIELD OF THE INVENTION

This disclosure will describe my invention on a commercial /residential heating oil status monitoring system that will revolutionize the local, regional, national and worldwide oil distribution and service industry.

### SUMMARY OF THE INVENTION

In the Northeastern area of the United States, people have a difficult time trying to lock in a price for home heating oil through a local distributor for a home residence. This invention would create an electronic fuel gauge that has full duplex capabilities to communicate its status out to a remote location. This would replace the present mechanical floating gauge or be an external device that is used with existing gauges, that presently is used in most consumer and business heating oil tanks. This could be done by connecting the fuel gauge to a (transponding device) built in modem on the fuel gauge or using a external modem that connects to a standard telephone line dial in or out modem, a cable modem or wireless modem. This could be used in conjunction with a software status monitoring program that could give the amount of fuel and or status in real-time or on a dial out basis when needed by a local oil delivery, major distributor or even OPEC and or local state or federal governments for consumer usage. This idea could also work on anything similar such as propane, natural gas or any stored material, that would benefit to know the status of the contents being stored.

How I see it working would take the guess-work out of the delivery distributor on knowing when it has to be refilled. This would benefit the distributor in a few ways.

1) The distributor would not have to roll one of his trucks on a tank that may be full and only needs 25 gallons to fill.

2) If a driver was on his last run for the day and still had some fuel left in his truck the oil distributing company either the night before or real-time poll his customers using the electronic fuel gauge in conjunction with the communications status monitoring software program to see where he could dump his fuel before returning back to his home base. This could go right to the driver via a mobile data solution.

3) It would also benefit the local distributor and service provider on a more accurate measurement of how much fuel he would need to order from a regional distributor to get a quick turn around on distributing the oil. Better inventory control which would have a better cash flow for his business and require less staffing. This could be a centralized operation when networking all the areas onto one platform.

4) It could also alert the distributor through a software program by sending a automatic (with adjustable thresholds) low level signal from the fuel gauge back to the local distributor a alert that the tank is low and needs a refill.

5) If we go deeper into this by using this communication and status monitoring devices and network them all together it could be a powerful tool for networking all this data together.

6) Now any distributor could go and shop for the best prices via the world wide web from a middleman or broker(me) which I could use to distribute without having a holding facility and arrange for local drop off to world wide, national, regional, or local distributor.

7) Governments could use this information and a vehicle to know when to release reserves from federal storage, and when to buy at the cheapest rate.

8) This idea or theory could be used for many other applications.

9) You could also use this in conjunction by using the same technology to get the status of the oil burner.

### BRIEF DESCRIPTION OF THE DRAWINGS

FIG. 1 is a functional block diagram of my conception of the invention.

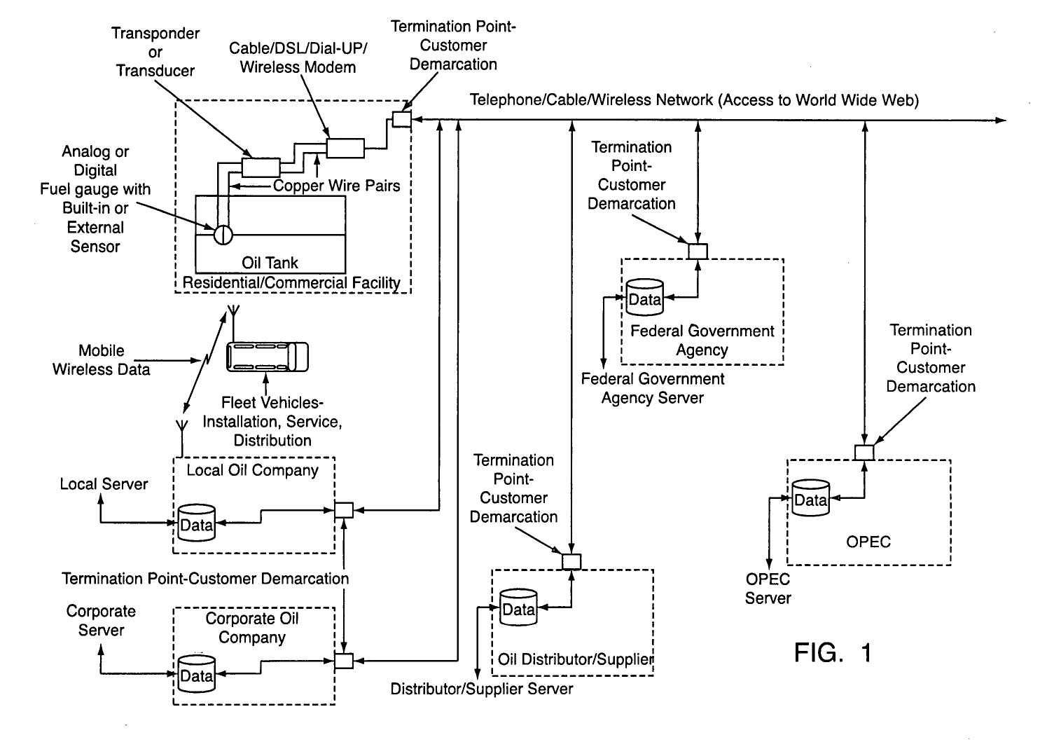

FIG. 2 is a preferred embodiment of my invention with the commercial telephone lines severing to interconnect the system and supplier, and an international agency such as OPEC.

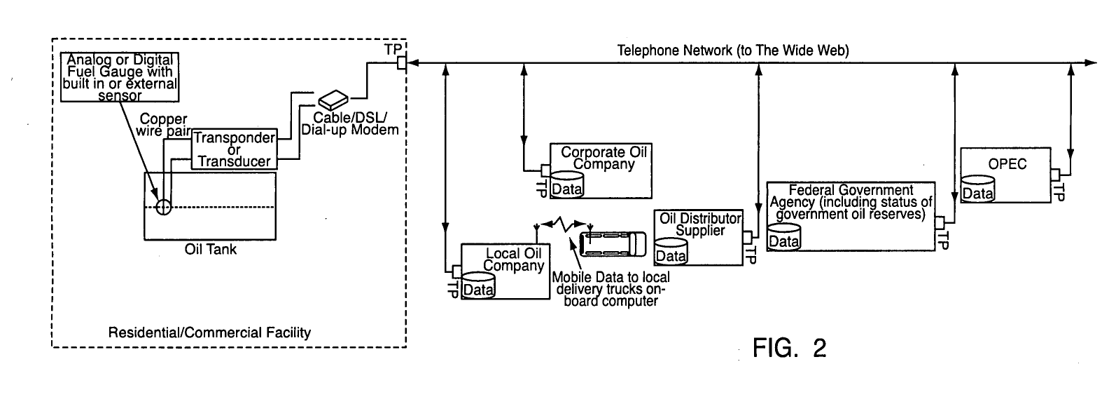

### GENERAL OVERVIEW

The general components and processes will consist of a single (or multiple) polling server that can reside wherever the database information will be warehoused that will have network connectivity for the companies or agencies it will serve. Additional backup or duplicate servers could reside either locally, regionally for a regional business structure, nationally and or worldwide for a corporate business structured company environment. These polling servers can be link to the service provider's consumers billing system and its associated database.

The server will contain database records of all of its customers, their contact numbers, customer premise equipment along with their preferred method of communications (i.e. Cable, dialup, DSL, wireless modem or through the worldwide web). Additional contained database information will be the company's current oil inventory storage tanks also to include what is in their current distribution vehicles fleet.

These servers will be capable of polling customers storage tanks on a scheduled time (daily, weekly, monthly etc.) basis or real-time for a more accurate reading. The polling can be initiated by the servers, the customer's modems and or transponder devices that can be triggered by predefined threshold limits on the current consumer's tanks oil fuel level via dry contact closures for an analog float system or digital pressure sensors that are currently used in the automobile and aviation industries gasoline fuel gauges today. One of the long term benefits of using this automated electronic polling and database storage is that the service provider will be able to create historical data based on consumer usage that will co-inside with the time of year for a more accurate future oil purchasing, storage and predicted inventory.

The customer premise equipment will consist of their current or new fuel storage tank(s), an existing or new fuel oil measuring device and or pressure sensor, external transducer that can supply power to the low voltage contact closures either located externally or incorporated within the fuel measuring gauge device for the transponding device with dry contact closures set for common US or metric scaling for fuel oil level limits contained in the storage tanks (i.e., level limits such as, °, Ω and full tank etc.). This information will be sent via a modem located in the consumers dwelling back to the service provider's main servers.

All customer oil status monitoring premise equipment can be installed near the customer's oil tank typically located in the basement of a home or business that is generally an ideal location due to the local telephone, cable, satellite or other communications service provider's demarcation point of the facility to enable communications connectivity to the consumers premise equipment.

Once the service provider receives the consumer's oil inventory status information the provider will have many options for communicating this information for distribution. Some of the simple forms of communicating this information out to the service provider's distribution fleet vehicles would be creating a work order either manually or automated that prints out the day or night before with the consumers address that are in need of a refill of oil. The service provider would then distribute that work order to their drivers in the morning for consumer delivery. Another form of communication would be in a service provider's dispatching environment using voice communications such as, cellular telephone and or two-way radios.

A more complex and short-term up front investment cost to the service provider distributing this information out to the service provider's oil distribution fleet of vehicles would be using wireless mobile data technology. This form of communicating the consumer's current oil storage levels out to the service provider's distribution fleet of vehicles would require the service providers to outfit and equipped their vehicles with a wireless personal computer, PDA or computer terminal with GPS capabilities. This would allow for real-time distribution along with the convenience of distributing service delivery work orders in real-time that could route the consumer addresses that are in need of a refueling directly out to the distributors fleet of vehicles in relationship to where the service provider's fleet of vehicle were currently located out in the field (by street, town, state etc). This will enable the service provider a means of controlling their oil inventory that will allow the service provider to purchase the correct amount of oil reducing their need for storage facilities and also have a quick turnover of their inventory. By doing this they would streamline their operations and reduce their operating expenses.

### Technical Description

This technical description will describe the three key component areas and how they integrate for my invention.

### Consumer's Facility

The consumer's facility will use a new or existing storage tank, calibrated float or pressure sensing fuel gauge sized for their oil storage tank. The fuel gauge will need to be capable of sending it current fuel status level by dry contact closures or digital binary bits either internally built in to the gauge itself or with an external connection point for a way of extracting the information to terminal screws located within the gauge or hardwired to a jack and plug connector set up for an external connection point. The form of data can be, but is not limited to serial data so that it can be adaptable (converted) to fit any type of electronic transport median format. This format can be customized to the consumers preferred method of communicating the current oil tanks fuel oil level back to the service provider's facility or where the current database resides, via dial up telephone, DSL, cable or wireless modem. The gauge will need to be capable of full duplex data communications so it will allow for the fuel oil level to be interrogated (accessed) by the main server and additionally having the capability for the oil level to be sent from the gauges transducing or transponding device back to the main server for general data information gathering. This will also include the capability for the gauge to send multiple types of alerts such as a low level alert back to the server. Powering the gauge, data converter, transducer and or transponding device can be accomplished though a standard 120V AC outlet using a transformer to either convert or step down the voltages to a common voltage to power all the necessary electronic devices requiring power.

The consumer's method of transporting their oil tanks fuel status data back to the service provider data warehouse (server) can be accomplished through many types of transport formats. Types of transports can be but are not limited to, dial-up telephone, Digital Subscriber Line “DSL”, Cable and wireless modems using a private and or a public network such as the World Wide Web. Using a DSL, Cable or wireless modem the consumer has the capability to be always up and always on, meaning that if the consumer chooses to keep their connection to the host or service provider the fuel oil status will be active anytime.

### Network

The type of network the consumer uses will be their choice. The data information gathered from the consumer's oil tank, can be accessed over a standard telephone circuit switch copper dial-up network or a hybrid network that uses a combination of fiber optics, coaxial cable, radio frequencies airwaves and or copper wires for broadband technology over the World Wide Web using a cable, DSL, or wireless service provider network. Whatever the choice of the network selected by the consumer, network reliability should be considered when selecting a service provider.

### Service Providers Facility

The oil distribution service provider's facility will have a windows based server running the communications software that will allow the consumers oil tanks fuel gauge to be accessed by the server. The servers will be tied to a router that will have connectivity to the public network with access to the World Wide Web.

The server will be configured to poll the consumer's fuel gauges on a schedule based on the amount of consumer's that receive oil from the service provider. Polling the consumers fuel gauges on a scheduled basis taking into consideration the quantity of fuel gauges that have to be polled, polling should be done in the late hours of the evening or in the very early morning hours to take advantage of the least amount of network traffic congestion on all service providers public networks.

The service provider will be capable of providing via an existing or new web page site that will give the customer a way to view their current oil tanks status locally and remotely as long as they have access to the World Wide Web or alternatively dial-up modem access to a predefined telephone number connected to a modem located within the service providers facility that is linked to the polling servers. As long as the consumer has access to a device that allows them to view media and or text content, they will be able to access their current oil tanks fuel oil level status. Additionally as previously mentioned the capability will exist to provide the consumer predefined oil level status alerts using their choice of communications device.

### Conclusion

My invention is designed as a very versatile product with a process that will assist the oil distribution industry with better inventory control, oil purchasing and service delivery that allows the distributor and the service provider to run a most cost effective business operation with better profit margins. Additionally the savings in operational expenses can be passed along to the consumers for better oil consumer prices.

I claim:

1. A system for monitoring oil/fuel requirements comprising:
a customer database for the storage of information peculiar to the oil/fuel, heating/cooling requirements of predetermined premises
oil/fuel storage tanks, oil/fuel quantity sensors, and data transmitting devices, to generate customer premise status signals for updating said customer database.
a supplier database for the storage of information peculiar to the oil/fuel inventory capabilities at pre-selected sources of oil/fuel,
a computer system for reviewing data from said customer and supplier databases, and a program for polling said customer database periodically for comparing the status of said customer premise status signals to a preprogrammed table that stores an output or preprogrammed data indicative of predetermined minimum oil/fuel levels for each premise, and said computer system generating a work order for those premises identified as below that level.

2. The combination according to claim 1 further characterized by oil/fuel inventory sensors, and transmitting devices, to generate supplier inventory signals for updating said supplier database.

3. The combination according to claim 1 wherein said signals are transmitted at least in part on the internet.

4. The combination according to claim 1 wherein said signals are transmitted at least in part over telephone/data communication wiring common to the customers premises for other purposes.

5. The combination according to claim 1 wherein said computer system is linked by modems and telephone/data communication lines for operation from a location remote from the computer system, the computer system comprising a server program to serve several oil/fuel suppliers.
The combination according to claim 1 wherein said transmitting devices operate on radio frequency at least in part.

7. The combination according to claim 1 wherein said periodic comparison is also responsive to a manual input inquiry from the premises of the customer.

8. The combination according to claim 1 wherein said periodic polling can be accomplished from a location remote from the computer system, which remote location is selected from the group comprising the premises of the customer, the supplier serving that customer, and the location of foresaid computer system.

9. The combination according to claim 1 further comprising oil/fuel inventory sensors, and transmitting devices to generate supplier inventory signals to update said supplier database, and said program further including means for generating purchase orders for the supplier or suppliers identified as having oil/fuel inventories below a preprogrammed level.
